(19) United States
(12) Patent Application Publication
(10) Pub. No.: US 2010/0090993 A1
(43) Pub. Date: Apr. 15, 2010

(54) LED PIXEL DRIVING CIRCUIT

(75) Inventor: Chang-Ho TSENG, Miaoli County (TW)

Correspondence Address: LOWE HAUPTMAN HAM & BERNER, LLP, 1700 DIAGONAL ROAD, SUITE 300, ALEXANDRIA, VA, 22314, US

(73) Assignee: TPO DISPLAYS CORP., Miao-Li County (TW)

(21) Appl. No.: 12/577,860

(22) Filed: Oct. 13, 2009

(30) Foreign Application Priority Data
Oct. 13, 2008 (TW) 97139166

(51) Int. Cl. G09G 5/00

(52) U.S. Cl. 345/204

(57) ABSTRACT

An OLED pixel driving circuit includes a storage capacitor, a first switching circuit, and a driving element. The storage capacitor has a first node and a second node, where the second node receives Data voltage in a first period, and the first node receives reference voltage in a second period within the first period. The first switching circuit isolates the first node from a fixed voltage source in the first period, and connects the first node to the fixed voltage source to provide a fixed voltage to the first node after the end of the first period. The driving element outputs a driving current independently of the fixed voltage.

### CROSS-REFERENCE TO RELATED APPLICATIONS

This application claims the right of priority based on Taiwanese Patent Application No. 97139166 entitled “LED PIXEL DRIVING CIRCUIT,” filed on Oct. 13, 2008, which is incorporated herein by reference and assigned to the assignee herein.

### FIELD OF INVENTION

The present invention relates to a pixel driving circuit and, in particular, to a pixel driving circuit for organic light emitting diode (OLED) or, in more particular, to a pixel driving circuit for active matrix organic light emitting diode (AMOLED).

### BACKGROUND OF THE INVENTION

Active matrix organic light emitting diode (AMOLED) displays are currently emerging next generation of flat panel displays. An AMOLED display has many advantages, such as, higher contrast ratio, wider viewing angle, quicker response, thinner and flexible module, self-luminescence without backlight, low power consumption as well as low cost. Thus AMOLED display could be the mainstream for the next-generation display.

FIG. 1 illustrates a conventional 2T1C (2 transistors M1-M2 and 1 capacitor Cst) circuit in an AMOLED display. The 2T1C structure is simple, but it may cause the non-uniformity of brightness over the panel. This is because, aside from the characteristic variation among the transistors, pixels in different positions would encounter different voltage drops.

As known, the gate-source voltage Vgs of the transistor M2 is equal to the difference between the data voltage Vdata and the power supply voltage Vdd. Therefore, different power supply voltages Vdd would cause the emitting device EL the brightness non-uniformity problem. US Patent Publication 2006/0023551, has been assigned to the same assignee herein, addresses the same problem. However, it uses a “power compensation” approach, which is more complicated and requires too many transistors.

Therefore, it is desired to have a new, simple, energy-saving pixel driving circuit for light emitting diode to improve display uniformity.

### SUMMARY OF THE INVENTION

With embodiments described in the specification, the present invention, in one aspect, provides a pixel driving circuit for OLED, wherein the storage capacitor is connected to a power supply via a switching circuit, and the storage capacitor is connected to a reference voltage source via another switching circuit. In addition, the power supply is independent of the reference voltage source on the panel. The present invention provides a less-complicated circuit design, and compared to the conventional approach, the present invention is easy to implement without incurring excessive cost and time.

In one embodiment disclosed is an OLED pixel driving circuit including a storage capacitor, a first switching circuit, and a driving element. The storage capacitor has a first node and a second node, where the second node receives data voltage in a first period, and the first node receives reference voltage in a second period, which is part of the first period. The first switching circuit isolates the first node from a fixed voltage source in the first period, and connects the first node to the fixed voltage source to provide a fixed voltage to the first node after the end of the first period. The driving element outputs a driving current independently of the fixed voltage. Particularly, the first switching circuit could be a PMOS transistor, the second switching circuit could be a NMOS transistor, the third switching circuit could be a NMOS transistor, and the driving element could be PMOS transistor. Moreover, after the end of the first period, the gate-source voltage of the driving element (PMOS transistor) is independent of the fixed voltage.

In another embodiment, the pixel driving circuit further includes a second switching circuit and a third switching circuit. In the first period, the second switching circuit is turned open in response to a first scan signal inputted from a first scan line, so the second node receives a data voltage from a data line. In the second period, which is part of the first period, the third switching circuit is turned open in response to a second scan signal inputted from a second scan line, so the first node receives a reference voltage from a reference voltage source.

In addition, the present invention provides a display, which includes a panel and a controller. The panel includes a pixel array, and the pixel array includes a plurality of aforementioned pixel driving circuits. Particularly, driving currents of the pixel driving circuits are substantially the same. Meanwhile the present invention also provides an electronic device including the aforementioned display.

The foregoing and other features of the invention will be apparent from the following more particular description of embodiment of the invention.

### BRIEF DESCRIPTION OF THE DRAWINGS

The invention will now be further described by way of example only with reference to the accompany drawings in which:

FIG. 1 shows conventional pixel driving circuit;

FIG. 2 illustrates an electronic device according to an embodiment of the present invention; and

FIGS. 3a-3f illustrate pixel driving circuits according to different embodiments of the present invention.

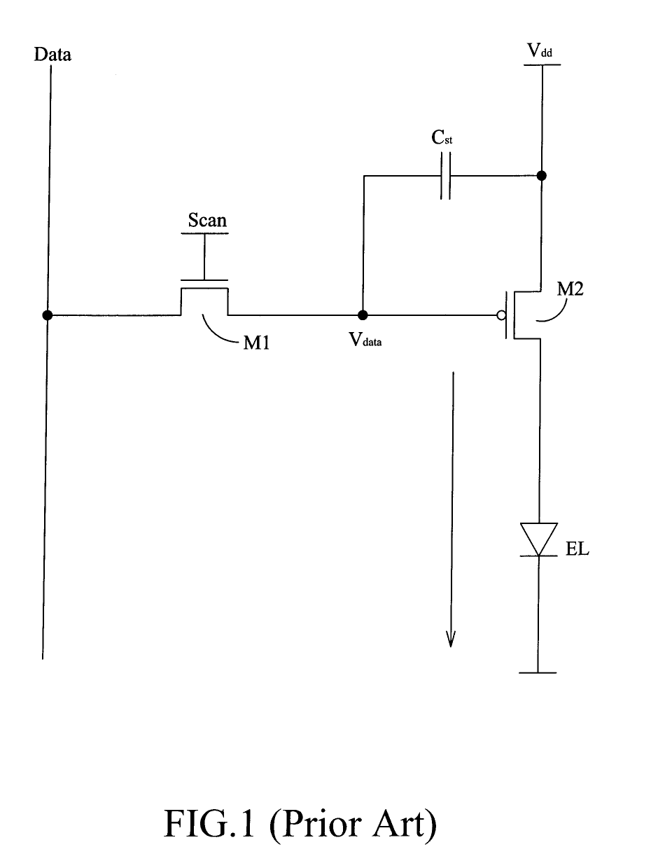

### DETAILED DESCRIPTION OF THE PREFERRED EMBODIMENTS

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments, particularly those sizes, scales, and relative positions shown in the drawings.

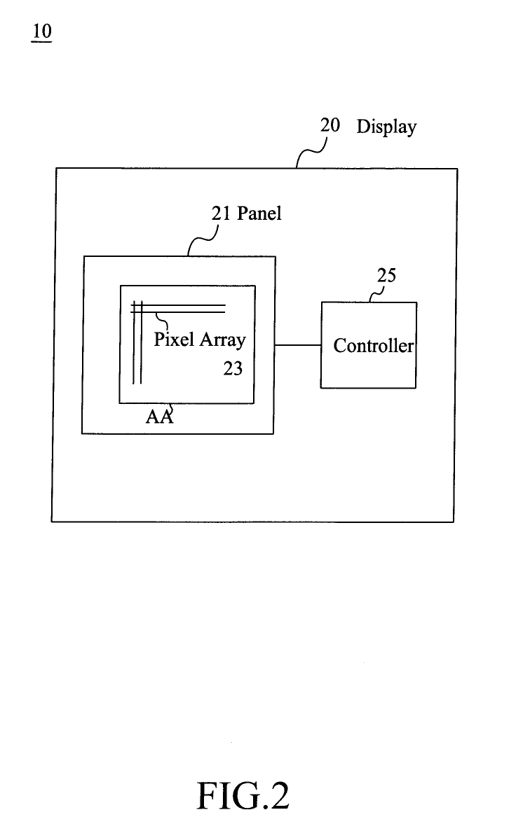

FIG. 2 is a block diagram of an electronic device 10 according to an embodiment of the present invention. In this embodiment, the electronic device 10 could be a TV, a mobile phone, a digital camera, a personal digital assistant (PDA), a notebook computer, a desktop computer, a television, a global positioning system (GPS), a car media player, an avionics display, a digital photo frame, a portable video player, etc. In this embodiment, the electronic device 10 includes an AMOLED display 20 and a controller 25. The AMOLED display 20 has a panel 21, and the panel 21 has an Active Area (AA) 22. A pixel array 23 in Active Area 22 has a plurality of data lines and scan lines. The controller 25 controls the operation of pixel driving circuits of the pixel array 23 to present images on the display 20.

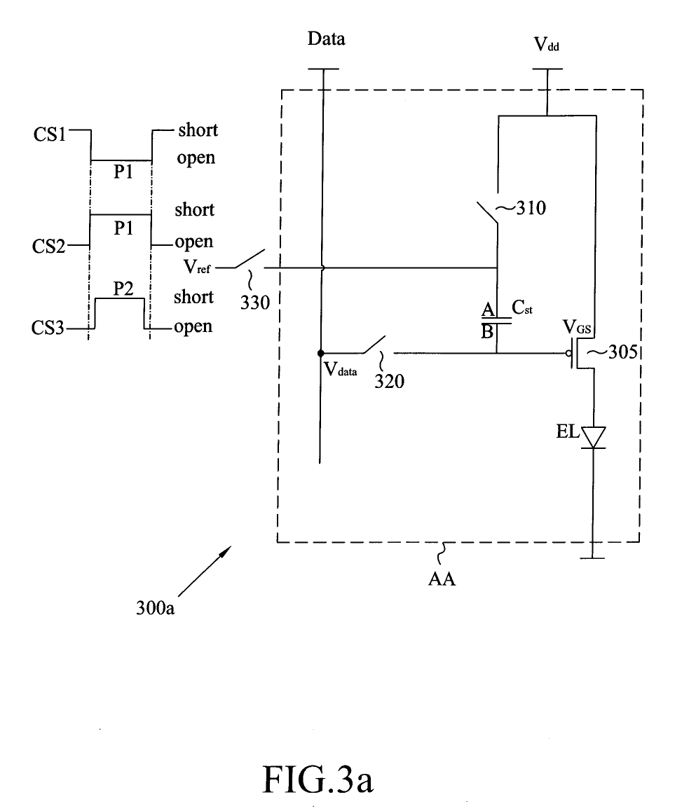

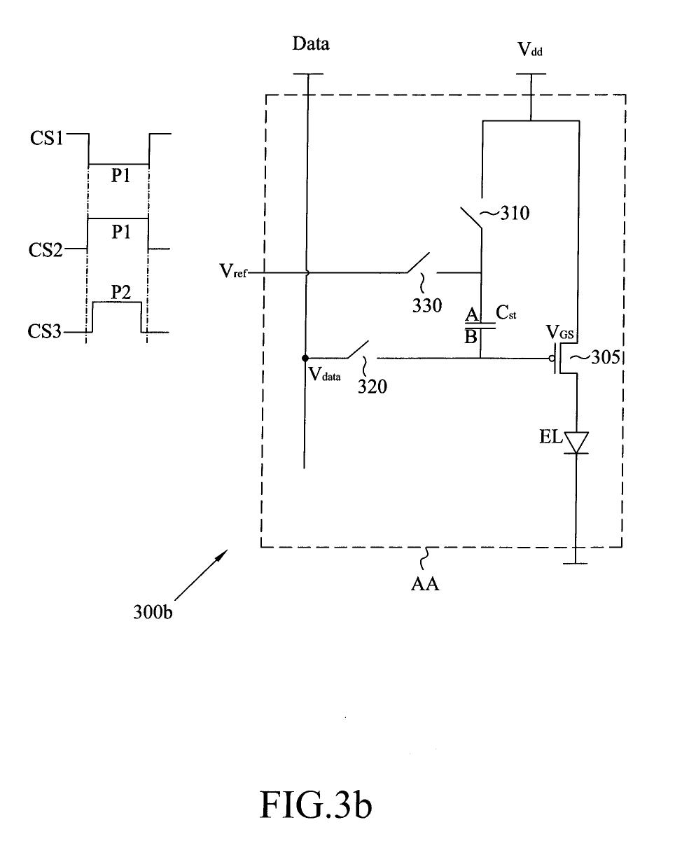

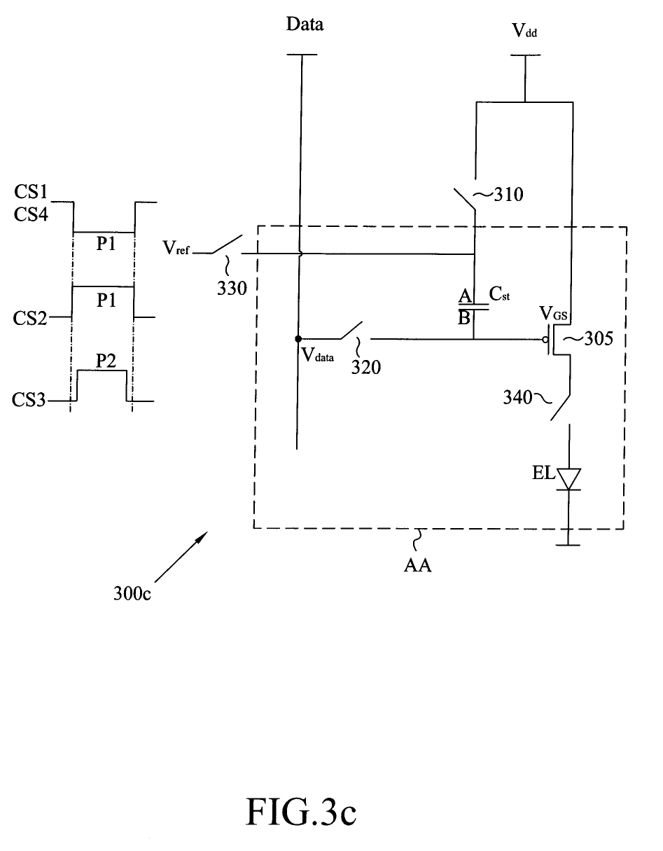

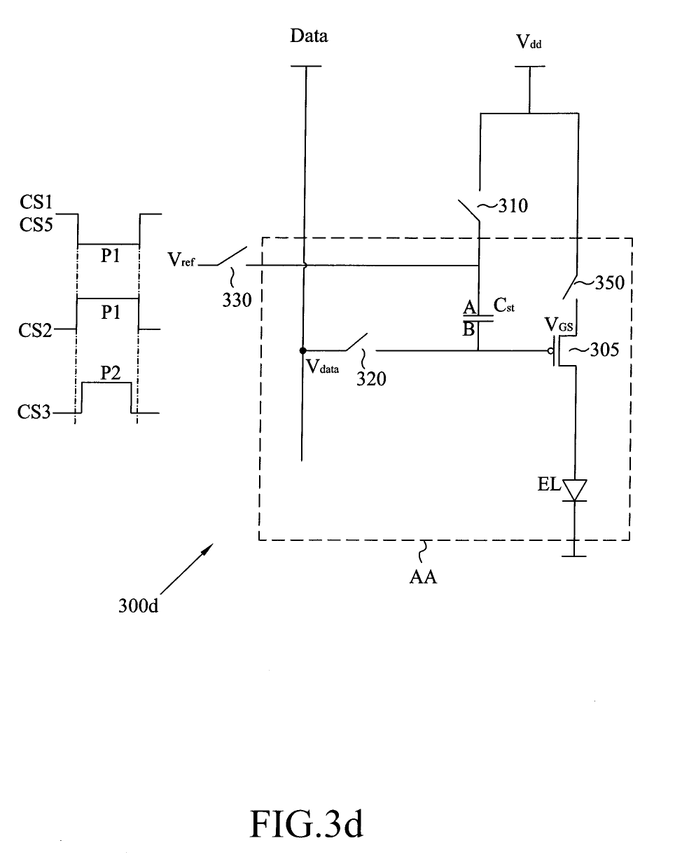

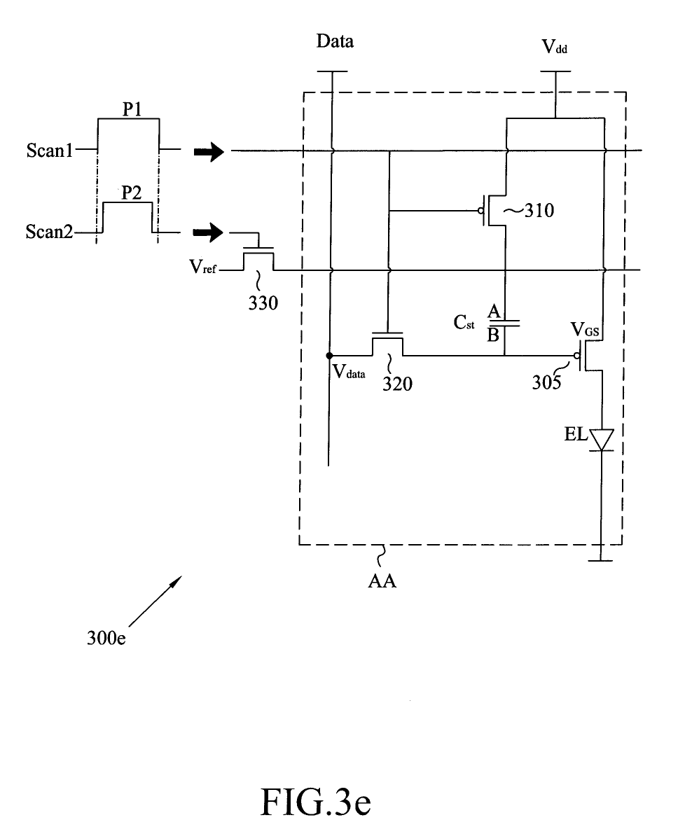

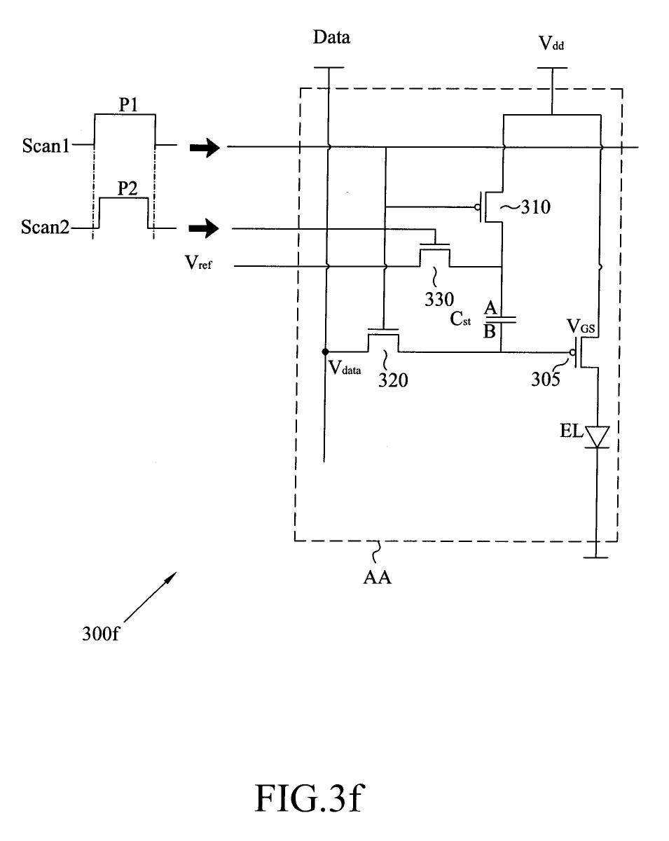

As shown in FIG. 3a, the pixel driving circuit 300a includes a storage capacitor Cst, a first switching circuit 310, a second switching circuit 320, a third switching circuit 330, and a driving element 305. The first switching circuit 310 is disposed between the first node A of the capacitor Cst and a fixed voltage source Vdd of the panel 21. Note that the fixed voltage source Vdd can output a voltage around 5V, for example. However, the actual voltage received by a pixel from the fixed voltage source Vdd would depend on the pixel position and thus is difficult to ascertain. The second switching circuit 320 is disposed between the second node B of the capacitor Cst and a data line Data of the panel 21. The third switching circuit 330 is disposed between the first node A of the capacitor Cst and a reference voltage source Vref of the panel 21. The driving element 305 could be a PMOS transistor, disposed between the fixed voltage source Vdd and the emitting device EL. As shown, the has a source connected to the fixed voltage source Vdd, a gate coupled to the second node B, and a drain connected to the emitting device EL.

Also as shown in FIG. 3a, the storage capacitor Cst, the first switching circuit 310, the second switching circuit 320, and the driving element 305 are all disposed within Active Area (AA) of the panel 21. The third switching circuit 330 is disposed outside Active Area (AA), but in the peripheral area of the panel 21. Note that one switching circuit 330 can support a number of pixels.

In an embodiment, the fixed voltage source Vdd is independent of the reference voltage source Vref on the panel 21. That is, there is no direct electrical connection between the fixed voltage source Vdd and the reference voltage source Vref. For example, the flexible PCB (not shown) for the pixel driving circuit 300a has different contact pins for the fixed voltage source Vdd and the reference voltage source Vref.

Operations of the pixel driving circuit 300a will be described in the following. In the first period P1, when the first switching signal CS1 goes from short level to open level, the first switching 310 is turned open to isolate the first node A of the capacitor Cst from the fixed voltage source Vdd of the panel 21. Then when the second switching signal CS2 goes from open level to short level, the second switching 320 is turned short to connect the second node B of the capacitor Cst to the data line Data of the panel 21.

The second period P2 starts after the beginning of the first period P1. Then in the second period P2, when the third switching signal CS3 goes from open level to short level, the third switching 330 is turned short to connect the first node A of the capacitor Cst to the reference voltage source Vref of the panel 21, and the first node A receives the reference voltage from the reference voltage source Vref. In this embodiment, the second period P2 starts at least 50 ns later after the beginning of the first period P1, and the second period P2 lasts at least 0.5 μs. Then in response to a timing signal (not shown), the data line Data writes the data voltage Vdata to the second node B, so the stored voltage across the storage capacitor Cst is (Vdata−Vref).

When the second period P2 comes to the end and the third switching signal CS3 goes from short level to open level, the third switching circuit 330 is turned open. Next, the first period P1 comes to the end, and when the first switching signal CS1 goes from open level to short level and the second switching signal CS2 goes from short level to open level, the second switching circuit 320 is turned open but the first switching circuit 310 is turned short. Thus the first node A is connected to the fixed voltage source Vdd, and the voltage at the first node A become Vdd. To maintain the stored voltage across the storage capacitor Cst, the voltage at the second node B becomes (Vdd+Vdata−Vref). In this embodiment, the first period P1 ends at least 50 ns later after the end of the second period P2.

The gate of PMOS transistor 305 is coupled to the second node B, so the gate voltage is equal to (Vdd+Vdata−Vref). The source of PMOS transistor 305 is coupled to the fixed voltage source Vdd to have the source voltage equal to Vdd, so the gate-source voltage Vgs of PMOS transistor 305 is equal to (Vdata−Vref), which is independent of the fixed voltage Vdd. Accordingly, the current outputted from the drain of PMOS transistor 305 would not be affected by the voltage drop of the fixed voltage Vdd. As a result, the brightness uniformity is improved.

Compared with the pixel driving circuit 300a, the pixel driving circuit 300b shown in FIG. 3b has a storage capacitor Cst, a first switching circuit 310, a second switching circuit 320, a third switching circuit 330, and a driving element 305 all disposed in Active Area (AA) of the panel 21. Except that, the pixel driving circuit 300a and the pixel driving circuit 300b have similar structure and operations. Therefore the details of the pixel driving circuit 300b are omitted herein.

FIG. 3c and FIG. 3d show other embodiments. Compared with the embodiments shown in FIG. 3a and FIG. 3b, the switching circuit 330c in FIG. 3c further includes a fourth switching circuit 340 disposed between the driving element 305 and the emitting device EL. In response to a fourth switching signal CS4, the fourth switching circuit 340 is turned open or short. In this embodiment, the fourth switching signal CS4 and the aforementioned first switching signal CS1 are the same one. When the first switching circuit 310 is turned short, the fourth switching circuit 340 is turned short too; when the first switching circuit 310 is turned open, the fourth switching circuit 340 is turned open too. In addition, the first switching circuit 310 and the third switching circuit 330 are both disposed outside Active Area (AA).

Compared with the embodiments shown in FIG. 3a and FIG. 3b, the switching circuit 330d in FIG. 3d further includes a fifth switching circuit 350 disposed between the driving element 305 and the fixed voltage source Vdd. In response to a fifth switching signal CS5, the fifth switching circuit 350 is turned open or short. In this embodiment, the fifth switching signal CS5 and the aforementioned first switching signal CS1 are the same one. When the first switching circuit 310 is turned short, the fifth switching circuit 350 is turned short too; when the first switching circuit 310 is turned open, the fifth switching circuit 350 is turned open too. In addition, as shown in FIG. 3d, the first switching circuit 310 and the third switching circuit 330 are both disposed outside Active Area (AA).

As for the pixel driving circuit 300e in FIG. 3e, the first switching circuit 310 includes a PMOS transistor; the second switching circuit 320 includes a NMOS transistor; the third switching circuit 330 includes a NMOS transistor; and the driving element 305 includes a PMOS transistor. However, those skilled in the art should understand that the present invention is not limited to these embodiments.

As shown in FIG. 3e, PMOS transistor 310 is disposed between the first node A of the capacitor Cst and the fixed voltage source Vdd of the panel 21. The source of PMOS transistor 310 is connected to the fixed voltage source Vdd, the gate is coupled to the first scan line Scan 1, and the drain is coupled to the first node A.

NMOS transistor 320 is disposed between the second node B of the capacitor Cst and the data line Data of the panel 21. The drain of NMOS transistor 320 is connected to the data line Data, the gate is coupled to the first scan line Scan 1, and the source is coupled to the second node B.

NMOS transistor 330 is disposed between the first node A of the capacitor Cst and the reference voltage source Vref of the panel 21. The drain of NMOS transistor 330 is connected to the reference voltage source Vref, the gate is coupled to the second scan line Scan 2, and the source is coupled to the first node A.

In addition, in the embodiment of FIG. 3e, PMOS transistor 310, NMOS transistor 320, and PMOS transistor 305 are disposed in Active Area (AA) of the panel 21. But NMOS transistor 330 is disposed outside Active Area (AA). Instead, NMOS transistor 330 is disposed in the peripheral area of the panel 21. This type of arrangement is also referred to as “3T1C” structure. Note that one NMOS transistor 330 can support more than one pixel. Moreover, PMOS transistor 310, NMOS transistor 320, NMOS transistor 330, and PMOS transistor 305 could be implemented as thin film transistors (TFT).

In the embodiment of FIG. 3f, PMOS transistor 310, NMOS transistor 320, NMOS transistor 330 and PMOS transistor 305 are disposed in Active Area (AA) of the panel 21. This type of arrangement is also referred to as “4T1C” structure. Except that, the pixel driving circuit 300f and the pixel driving circuit 300e have similar structure and operations. Therefore the details of the pixel driving circuit 300f are omitted herein.

Operations of the pixel driving circuit 300e or the circuit 300f will be explained in greater detail as follows. At first, in the first period P1, the first scan line SCAN 1 is pulled high to output a first scan signal to gates of PMOS transistor 310 and of NMOS transistor 320, to make PMOS transistor 310 off but to make NMOS transistor 320 on.

After the beginning of the first period P1, the second scan line SCAN 2 in the second period P2 is pulled high to output a second scan signal to the gate of NMOS transistor 330, to make NMOS transistor 330 on, so the first node A receives the reference voltage from the reference voltage source Vref. Then in response to a timing signal (not shown), the data line Data writes the data voltage Vdata to the second node B, so the stored voltage across the storage capacitor Cst is (Vdata−Vref).

Next, the second scan line SCAN 2 is pulled low and the second period P2 comes to the end. After that, the first scan line SCAN 1 is also pulled low and the first period P1 comes to the end too. Meanwhile, NMOS transistor 320 is turned off and the PMOS transistor 310 is turned on, so that the first node A is connected to the fixed voltage source Vdd, and the voltage at the first node A becomes Vdd. But to maintain the stored voltage across the storage capacitor Cst, the voltage at the second node B becomes (Vdd+Vdata−Vref).

The gate of PMOS transistor 305 is coupled to the second node B, so the gate voltage is equal to (Vdd+Vdata−Vref). The source of PMOS transistor 305 is coupled to the fixed voltage source Vdd to have the source voltage equal to Vdd, so the gate-source voltage Vgs of PMOS transistor 305 is equal to (Vdata−Vref), which is independent of the fixed voltage Vdd. Accordingly, the current outputted from the drain of PMOS transistor 305 would not be affected by the voltage drop of the fixed voltage Vdd. As a result, the brightness uniformity could be improved.

While this invention has been described with reference to the illustrative embodiments, these descriptions should not be construed in a limiting sense. Various modifications of the illustrative embodiment, as well as other embodiments of the invention, will be apparent upon reference to these descriptions. It is therefore contemplated that the appended claims will cover any such modifications or embodiments as falling within the true scope of the invention and its legal equivalents.

We claim:

1. An OLED pixel driving circuit, comprising:
a storage capacitor, having a first node and a second node, wherein said second node receives data voltage in a first period, and said first node receives a reference voltage in a second period within said first period;
a first switching circuit, disposed between said first node and a fixed voltage source, provided for isolating said first node from said fixed voltage source in said first period, and for connecting said first node to said fixed voltage source to provide a fixed voltage to said first node after the end of said first period; and
a driving element, respectively coupled to said fixed voltage source and said second node, provided for outputting a driving current independent of the fixed voltage after the end of said first period.

2. The pixel driving circuit according to claim 1, wherein said first witching circuit is a thin film transistor (TFT) and has a first terminal, a second terminal, and a third terminal;
wherein said first terminal is coupled to said fixed voltage source, said second terminal is coupled to said first node, and said third terminal is connected to a first scan line;
wherein said first switching circuit is turned open in response to a first scan signal inputted from said first scan line in said first period.

3. The pixel driving circuit according to claim 2, wherein said first switching circuit comprises a PMOS transistor.

4. The pixel driving circuit according to claim 1, further comprising a second switching circuit between a data line and said second node;
wherein said second switching circuit is turned short in said first period and said second node receives said data voltage from said data line.

5. The pixel driving circuit according to claim 4, wherein said second switching circuit is a TFT and has a first terminal, a second terminal, and a third terminal;
wherein said first terminal is connected to said data line, said second terminal is coupled to said second node, and said third terminal is connected to a first scan line;
wherein said second switching circuit is turned short in response to a first scan signal inputted from said first scan line in said first period.

6. The pixel driving circuit according to claim 5, wherein said second switching circuit comprises a NMOS transistor.

7. The pixel driving circuit according to claim 5, wherein said third switching circuit is a TFT and has a first terminal, a second terminal, and a third terminal;
wherein said first terminal is connected to a reference voltage source, said second terminal is coupled to said first node, and said third terminal is connected to a second scan line;
wherein said third switching circuit is turned short in response to a second scan signal inputted from said second scan line in said second period, and said first node receives said reference voltage from said reference voltage source.

8. The pixel driving circuit according to claim 1, wherein said driving element is a TFT and has a first terminal, a second terminal, and a third terminal;
wherein said first terminal is connected to said fixed voltage source, said second terminal is coupled to said second node, and said third terminal outputs said driving current.

9. The pixel driving circuit according to claim 8, wherein said driving element is a PMOS transistor and has a source, a gate, and a drain;
wherein said source is connected to said fixed voltage source, said gate is coupled to said second node, and said drain outputs said driving current;
wherein a gate-source voltage of said driving element is independent of said fixed voltage after the end of said first period.

10. The pixel driving circuit according to claim 9, wherein said gate-source voltage of said driving element is equal to a difference between said data voltage and said reference voltage.

11. The pixel driving circuit according to claim 1, comprising a third switching circuit between a reference voltage source and said first node;
wherein said third switching circuit is turned short in said second period and said first node receives said reference voltage from said reference voltage source.

12. The pixel driving circuit according to claim 11, wherein said third switching circuit is a TFT and has a first terminal, a second terminal, and a third terminal;
wherein said first terminal is connected to said reference voltage source, said second terminal is coupled to said first node, and said third terminal is connected to a second scan line;
wherein, in said second period, said third switching circuit is turns short in response to a second scan signal inputted from said second scan line.

13. The pixel driving circuit according to claim 12, wherein said third switching circuit comprises a NMOS transistor.

14. The pixel driving circuit according to claim 1, wherein said second period starts at least 50 ns later after the beginning of said first period.

15. The pixel driving circuit according to claim 1, wherein said second period lasts at least 0.5 μs.

16. The pixel driving circuit according to claim 1, wherein said first period ends at least 50 ns later after the end of said second period.

17. A display, comprising:
a pixel array comprising a plurality of pixel driving circuits as claimed in claim 1; and
a controller operatively coupled to said pixel array, controlling the operations of said pixel driving circuits.

18. The display according to claim 17, wherein driving currents of said pixel driving circuits are substantially the same.

19. An electronic device, comprising the display as claimed in claim 17, wherein said electronic device is a TV, a mobile phone, a digital camera, a personal digital assistant (PDA), a notebook computer, a desktop computer, a television, a global positioning system (GPS), a car media player, an avionics display, a digital photo frame, or a portable video player.

20. The electronic device according to claim 19, wherein driving currents of said pixel driving circuits are substantially the same.
